(19) United States
(12) Patent Application Publication
(10) Pub. No.: US 2016/0042214 A1
(43) Pub. Date: Feb. 11, 2016

(54) Systems and Methods for Monitoring System Components and Stored Content using NFC Tags

(71) Applicant: CLINICARE LTD., Raanana (IL)

(72) Inventor: Doron BARACK, Raanana (IL)

(21) Appl. No.: 14/455,960

(22) Filed: Aug. 11, 2014

(51) Int. Cl. G06K 7/10; G06K 19/07; H04B 5/00

(52) U.S. Cl. CPC G06K 7/10366; H04B 5/0056; G06K 7/10297; G06K 19/0727

(57) ABSTRACT

A system for monitoring a period of use of components includes a number of components each having an integrated or attached NFC tag and a monitoring system. The monitoring system includes a processing system, an NFC reader and an output device for providing information to a user. The monitoring system is configured to read data from an NFC tag of one of said components brought into proximity to said NFC reader and determine whether said component has been previously used. For a previously used component, the monitoring system generates an indication to a user of a period-of-use status. For a component not previously used, the monitoring system stores data indicative of a first date of use of the component. Also disclosed is a system for monitoring the expiration date of perishable goods.

### FIELD AND BACKGROUND OF THE INVENTION

The present invention relates to systems and methods for monitoring system components and stored content using NFC tags.

In a wide range of applications, various interchangeable components are meant to be replaced periodically. Examples include: breast shields and bottles for use with breast pumps, filter units for use in water filters, and infusion sets for drug delivery devices. In certain cases, especially where the recommended period of use extends over weeks or months, it is difficult for many users to keep track of when the components were taken into use and when they should be replaced. Failure to replace the interchangeable components in a timely manner may, depending on the application, result in suboptimal operation of the device and/or potential health risks.

A further common issue is the difficulty in keeping track of storage times for items with a limited shelf-life. For example, in the case of a nursing mother storing portions of breast milk, the period for which the milk can be kept varies according to the storage conditions, and there may be many portions in storage at any given time with different effective expiration dates. Keeping track reliably of all of the portions and their relevant dates can be challenging.

### SUMMARY OF THE INVENTION

The present invention provides systems and methods for monitoring system components and stored content using NFC tags.

The term “NFC tag” is used herein to refer generically to any and all implementation of a passive RFID chip configured to communicate selectively with compatible readers located in close proximity (i.e., less than 10 cm) to the tag. This includes tags conforming to any of the current NFC standards as well as any further developments of that technology or alternative technological solutions which fall within the above generic definition, and independent of the name used to refer to such technology.

The term “NFC tag reader” is used to refer to any device configured to communicate with the NFC tags employed by the present invention. The “reader” is so called to reflect its primary essential function of reading the tags but, as will be clear from the description below, in certain preferred implementations, is also a tag writer.

According to the teachings of an embodiment of the present invention there is provided, a system for monitoring a period of use of components, the system comprising: (a) a plurality of components each having an integrated or attached NFC tag; and (b) a monitoring system comprising: (i) a processing system comprising at least one processor coupled to a data storage device, (ii) an NFC reader associated with the processing system, and (iii) an output device for providing information to a user, wherein the monitoring system is configured to: (A) read data from an NFC tag of one of the components brought into proximity to the NFC reader; (B) determine from the read data whether the component has been previously used; (C) for a previously used component, generate via the output device an indication to a user of a period-of-use status; and (D) for a component not previously used, store data indicative of a first date of use of the component.

According to a further feature of an embodiment of the present invention, the monitoring system is configured to store the data indicative of a first date of use by writing the data to the NFC tag.

According to a further feature of an embodiment of the present invention, the monitoring system is further configured, after writing the data to the NFC tag, to lock the NFC tag.

According to a further feature of an embodiment of the present invention, the indication of a period-of-use status includes at least one indication selected from the group consisting of a time until recommended replacement; a recommended date for replacement; and a due-for-replacement indication.

According to a further feature of an embodiment of the present invention, the plurality of components are interchangeable components configured for use with a device, and wherein the monitoring system is integrated as a part of the device.

According to a further feature of an embodiment of the present invention, each of the NFC tags is pre-programmed with an expiration date for use of the corresponding component, and wherein the monitoring system is further configured to generate an expiration output if the expiration date has passed.

According to a further feature of an embodiment of the present invention, each of the NFC tags is pre-programmed with a compatibility code indicative of compatibility between the corresponding component and the device, and wherein the monitoring system is further configured to verify the compatibility code.

According to a further feature of an embodiment of the present invention, the components are interchangeable components of a breast pump, and wherein the device includes a suction-generating pump.

According to a further feature of an embodiment of the present invention, the components are interchangeable components for receiving blood samples, and wherein the device includes a blood sugar monitor.

According to a further feature of an embodiment of the present invention, the components are interchangeable components of a drug delivery system, and wherein the device includes a drug delivery pump.

According to a further feature of an embodiment of the present invention, the components are interchangeable filter units, and wherein the device is a water filter.

According to a further feature of an embodiment of the present invention, the monitoring system is implemented using hardware components of a mobile communications device configured by installation of a software package.

There is also provided according to the teachings of an embodiment of the present invention, a method for monitoring a period of use of components, the method comprising the steps of: (a) providing a plurality of components each having an integrated or attached NFC tag; and (b) providing a monitoring system comprising: (i) a processing system comprising at least one processor coupled to a data storage device, (ii) an NFC reader associated with the processing system, and (iii) an output device for providing information to a user, (c) reading data from an NFC tag of one of the components brought into proximity to the NFC reader; (d) determining from the read data whether the component has been previously used; (e) for a previously used component, generating via the output device an indication to a user of a period-of-use status; and (f) for a component not previously used, storing data indicative of a first date of use of the component.

There is also provided according to the teachings of an embodiment of the present invention, a system comprising: (a) a plurality of storage containers each having an integrated or attached NFC tag; and (b) a monitoring system comprising: (i) a processing system comprising at least one processor coupled to a data storage device, (ii) an NFC reader associated with the processing system, (iii) an input device for receiving inputs from a user, and (iv) an output device for providing information to a user, wherein the monitoring system is configured to: (A) read data from an NFC tag of one of the storage containers brought into proximity to the NFC reader; (B) receive at least one user input via the input device indicative of a shelf-life parameter for content of the storage container; and (C) store data indicative of an expiration date for the content of the storage container.

According to a further feature of an embodiment of the present invention, the monitoring system is configured to store the data indicative of an expiration date by writing the data to the NFC tag.

According to a further feature of an embodiment of the present invention, the monitoring system is implemented using hardware components of a mobile communications device configured by installation of a software package.

According to a further feature of an embodiment of the present invention, the monitoring system is configured to be responsive to the at least one user input to define a type of content of the storage container.

According to a further feature of an embodiment of the present invention, the monitoring system is configured to be responsive to the at least one user input to define at least one of the group consisting of: a production date of the content of the storage container; and a storage date of the content of the storage container.

According to a further feature of an embodiment of the present invention, the monitoring system is configured to be responsive to the at least one user input to define a storage condition selected from at least two options, wherein the at least two options belong to the group consisting of: room temperature storage; refrigerated storage; ice-compartment storage; and deep-freeze storage.

According to a further feature of an embodiment of the present invention, the storage containers are interchangeable bottles for use with a milk-pump system, and wherein the NFC tags are integrated into the interchangeable bottles.

According to a further feature of an embodiment of the present invention, the NFC tags are integrated into stickers for attachment to the storage containers.

There is also provided according to the teachings of an embodiment of the present invention, a method comprising the steps of: (a) providing a plurality of storage containers each having an integrated or attached NFC tag; and (b) providing a monitoring system comprising: (i) a processing system comprising at least one processor coupled to a data storage device, (ii) an NFC reader associated with the processing system, (iii) an input device for receiving inputs from a user, and (iv) an output device for providing information to a user, (c) read data from an NFC tag of one of the storage containers brought into proximity to the NFC reader; (d) receive at least one user input via the input device indicative of a shelf-life parameter for content of the storage container; and (e) store data indicative of an expiration date for the content of the storage container.

### BRIEF DESCRIPTION OF THE DRAWINGS

The invention is herein described, by way of example only, with reference to the accompanying drawings, wherein:

FIG. 1 is a schematic isometric view of a system according to an embodiment of the present invention for monitoring system components;

FIG. 2 is a block diagram of a monitoring system from the system of FIG. 1;

FIG. 3 is a schematic representation of an alternative implementation of a monitoring system for use in the system of FIG. 1;

FIG. 4 is a flow diagram illustrating operation of the system of FIG. 1;

FIG. 5 is a schematic representation of a monitoring system according to a further aspect of the present invention;

FIGS. 6A-6C illustrate sets of storage containers for use in a system with the monitoring system of FIG. 5;

FIG. 7 is a flow diagram illustrating a mode selection operation of the monitoring system of FIG. 5;

FIG. 8 is a flow diagram illustrating operation of the monitoring system of FIG. 5 for recording storage of a new batch of content; and

FIG. 9 is a flow diagram illustration operation of the monitoring system of FIG. 5 to suggest a stored batch for next use.

### DESCRIPTION OF THE PREFERRED EMBODIMENTS

The present invention provides systems and methods for monitoring system components and stored content using NFC tags.

The principles and operation of systems and methods according to the present invention may be better understood with reference to the drawings and the accompanying description.

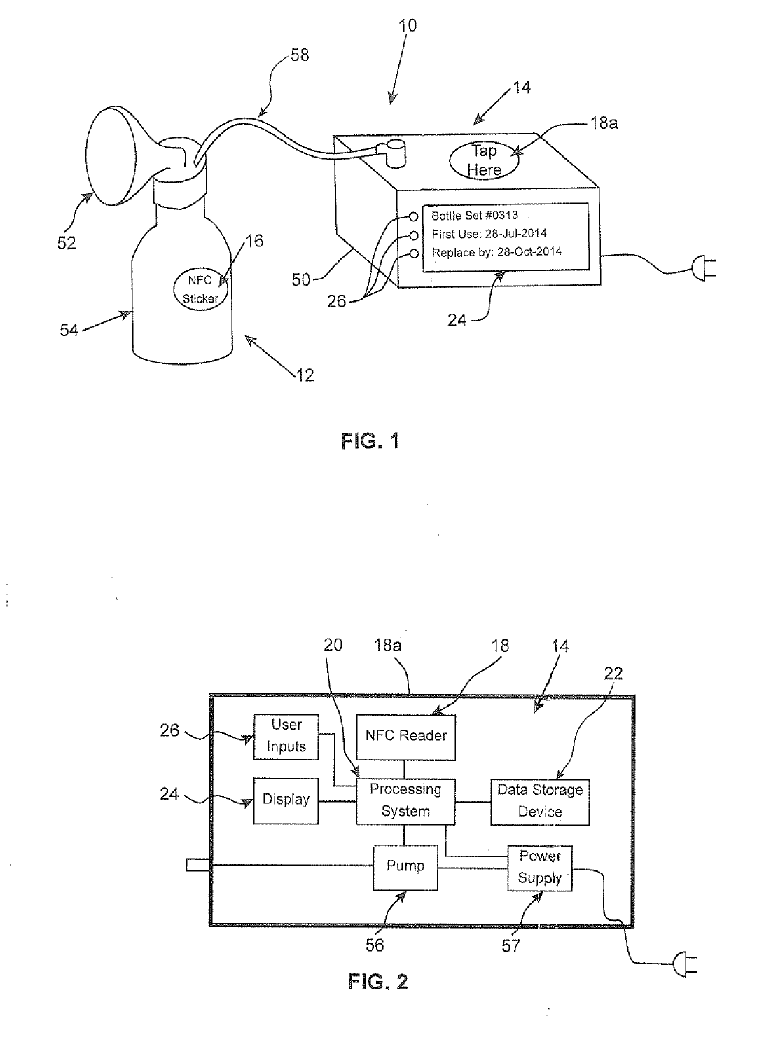

Referring now to the drawings, FIGS. 1-4 illustrate a system and method according to certain implementations of a first aspect of the present invention. Specifically, FIG. 1 illustrates an exemplary implementation of a system, generally designated 10, constructed and operative according to an embodiment of the present invention, in which a number of interchangeable components 12 are used together with a monitoring system 14. Each interchangeable component 12 includes an integrated or attached NFC tag 16.

The components of monitoring system 14 are illustrated in FIG. 2, and include an NFC reader 18 deployed in close proximity to a designated NFC touch-surface 18a so as to communicate with NFC tags brought into proximity with touch-surface 18a. Monitoring system 14 also includes a processing system 20 having at least one processor coupled to a data storage device 22. Monitoring system also includes an output device, exemplified here as a display 24, for providing information to a user, and preferably also at least one user input device 26.

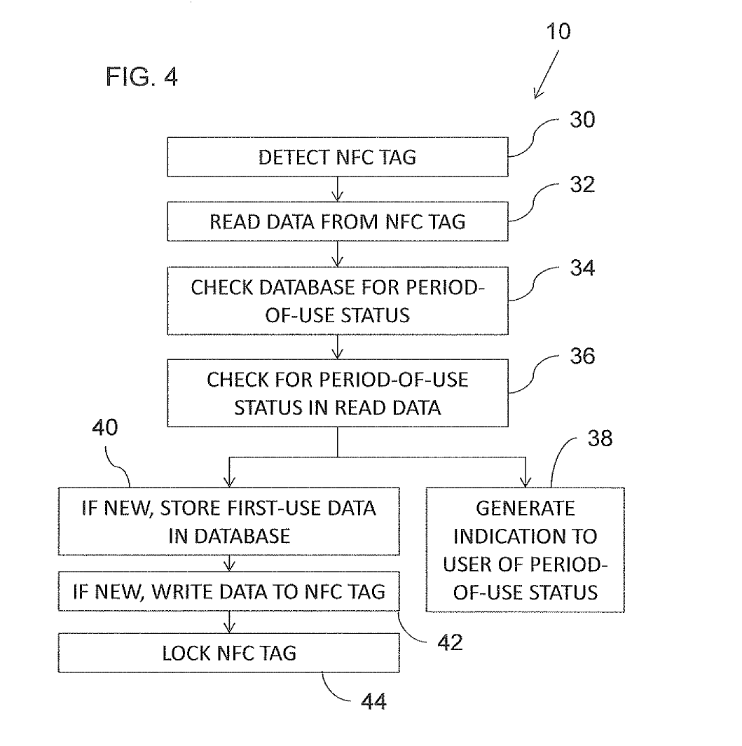

The operation of monitoring system 14 according to one implementation of this aspect of the present invention is illustrated in the form of a flow diagram in FIG. 4. Monitoring system 14 actuates NFC reader 18, either continuously or in response to a user input initiating the detection process, to detect an NFC tag brought into proximity to touch-surface 18a (step 30), and to read data therefrom (step 32). The system then preferably checks whether information is available as to the period of use for the particular tag that was read and its corresponding component.

Either or both of two approaches may be used to store and retrieve information regarding the period-of-use of the NFC tag and its corresponding component. According to a first approach, data regarding the date of first use, and/or a corresponding date for recommended replacement, is stored in a database, typically in data storage device 22. According to this option, at step 34, a check of the database is performed to assess whether data is stored relating to the detected NFC tag which would indicate prior use and would provide sufficient information to determine the period-of-use status. This approach can be used even in an implementation with read-only NFC tags, which may provide no information beyond a simple unique tag identifier. Optionally, if suitable WAN components are provided (not shown), the database information can also be uploaded and shared via a cloud server or other commonly available data storage to allow it to be shared between multiple monitoring systems, thereby determining period-of-use status for components transferred from one system to another.

As an addition or alternative, in some cases, data sufficient to indicate or allow derivation of the suggested period-of-use may be written to NFC tag 16 on first use. In this case, at step 36, the data read from the NFC tag is preferably processed to determine whether such period-of-use status information is present in the read data.

If either step 34 or step 36 indicate that the component has previously been used, and period-of-use data can be derived, the system preferably generates for the user an indication of the period-of-use status (step 38), typically via display 24 and/or by appropriately defined audio signals such as a short beep for a valid period-of-use suited for ongoing usage, and a sequence of beeps or an extended buzz to indicate a component due (or overdue) for replacement.

If on the other hand, the tag is determined to be new (by absence from the database or by lack of relevant first-use data stored in the tag, as relevant, or by both criteria), data indicative of a first date of use of the component is then stored. Here too, according to the approach used by the system, this may include writing the first-use data to a database (step 40) and/or writing the appropriate data to the NFC tag (step 42). Where data relating to a first use of the interchangeable component is written to the tag, the tag may advantageously be locked after writing (step 44) to prevent overwriting of the data.

Parenthetically, it will be noted that the present document various implementations of the present invention relate to components with a predefined recommended period of use from first usage until recommended replacement date. In such cases, it is possible to store either the first use date or the recommended replacement date in the database and/or the NFC tag, since each can be trivially derived from the other. Thus, wherever reference is made herein in the description and claims to either the date of first use of the date of recommended replacement, it should be understood to encompass the case where the other of these two parameters, or any other parameter which can be used to derive the recommended replacement date, is used. The phrase “period of use data” is used to refer generically to any and all such data.

Similarly, the phrase “period-of-use status” is used generically to refer to any and all indications as to whether a component is still within its recommended period for use, how much time remains until the recommended time for replacing the component, at what date the component should be replaced, or whether the component is due (including overdue) for replacement.

Referring now again to FIGS. 1 and 2, according to one particularly preferred but non-limiting set of implementations of the present invention, the plurality of components 12 are interchangeable components configured for use with a device 50 and monitoring system 14 is integrated as a part of that device 50. By way of a first example, FIGS. 1 and 2 illustrate an implementation in which components 12 are interchangeable components of a breast pump, including a breast shield 52 and a bottle 54. In this case, device 50 includes a suction-generating pump 56, powered by a power supply 57, for connection via tubing 58 to bottle 54.

Optionally, each component from a set of components, such as breast shield 52 and bottle 54, may have a separate NFC tag, and may be monitored by monitoring system 14 separately. However, where a group of components are normally used together and replaced at the same time, it is typically sufficient to use one tag per set.

Other types of devices for which the present invention can be implemented to advantage, including implementations in which the monitoring system is integrated with the long-term-use part of the device, include but are not limited to:
interchangeable components for receiving blood samples as part of a blood sugar monitor;
interchangeable components of a drug delivery system for use with a device including a drug delivery pump; and
interchangeable filter units for use with a water filter.

Depending upon the specific application, integration of monitoring system 14 with a long-term-use part of a system may also facilitate additional or alternative valuable functionality. By way of example, in certain cases, the period of use of replaceable components may be limited by an expiration date, typically defined as a given period after the date of manufacture, even if not used. According to one particularly preferred option, each of the NFC tags 16 is pre-programmed with an expiration date (i.e., data from which the expiration date can readily be derived) for use of the corresponding component, and monitoring system 14 is further configured to generate an expiration output if the expiration date has passed. This feature is particularly of value for a range of applications in which the interchangeable component includes a drug or reagent, or needs to be sterile.

An additional or alternative functionality which can be provided by the present invention is to verify compatibility between the replaceable component(s) and the device with which they are to be used. In this case, each NFC tag 16 is pre-programmed with a compatibility code indicative of compatibility between the corresponding component and the device, and monitoring system 14 is configured to verify the compatibility code. One subset of examples where such a compatibility verification may be important is drug delivery devices, where the verification may be used to ensure that only the correct type and/or concentration of drug is used with the device.

In the above examples, it is possible to implement a denial-of-service option wherein operation of the device is disabled or interrupted until various conditions are met. In cases such as a breast pump set or a water filter where no immediate harm will come from delaying replacement of the replaceable components, an advisory-only mode of operation is typically preferred. In cases of medical devices with expiration dates or compatibility verification, a denial-of-service mode may be preferred in relation to at least some warning conditions.

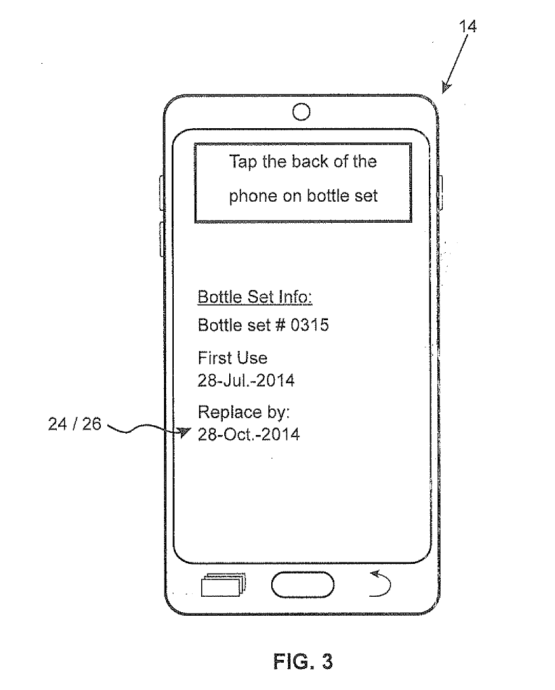

Turning now to FIG. 3, this illustrates an alternative implementation of monitoring system 14 using hardware components of a mobile communications device appropriately configured by installation of a software package. Many commercially available mobile communications devices include an NFC reader 18, and can therefore satisfy the hardware requirements of FIG. 2 (without the pump). In many cases, display 24 and user inputs 26 are both provided by a touch-screen, as shown. After configuring the mobile communications device by installation of appropriate software operating under a suitable operating system, such as Android™ or iOS™, operation of monitoring system 14 is essentially similar to that described above with reference to FIGS. 1, 2 and 4.

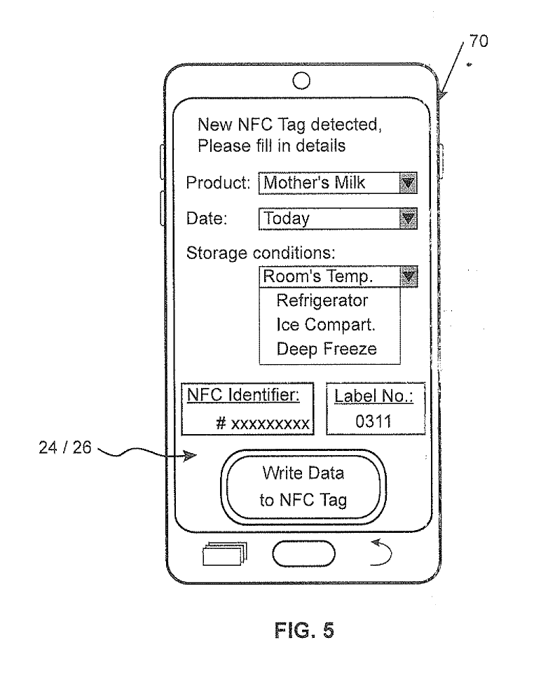

Turning now to FIGS. 5-9, a further aspect of the present invention will be described relating to monitoring of expiration dates for perishable goods in storage, and particularly, for home-stored content stored in storage containers.

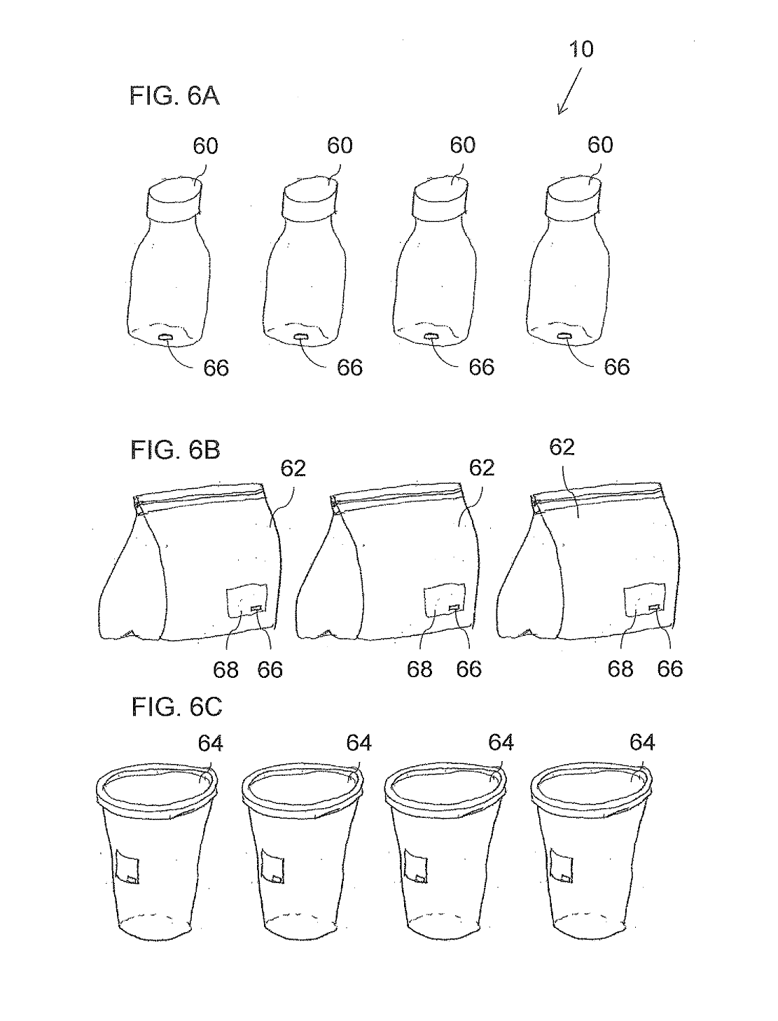

Referring to FIGS. 5 and 6A-6C, the system includes a plurality of storage containers, such as milk pump bottles 60 (FIG. 6A), resealable storage bags 62 (FIG. 6B) and/or other disposable or reusable storage containers 64 (FIG. 6C). Each storage container has an integrated or attached NFC tag 66, preferably combined with a label 68 or other visual marking carrying a number or other identifier. According to one preferred option, integration of NFC tags into stickers with identifying indices on them provides particularly advantageous flexibility of use, allowing the use of an arbitrary selection of storage containers of various types and sizes. The indices of the stickers are preferably included in pre-written data stored on the integrated NFC tag.

A monitoring system. 70 (FIG. 5) of this system includes hardware components generally similar to those of FIG. 2, some of which are not visible in the view of FIG. 5, including a processing system 20 with one or more processor coupled to a data storage device 22, an NFC reader 18 associated with the processing system, an input device 26 for receiving inputs from a user, and an output device 24 for providing information to a user. The monitoring system is preferably configured to perform one or more functions, including a “new batch storage” process, to be expounded upon below with reference to FIG. 8, which typically includes at least reading data from an NFC tag of one of the storage containers brought into proximity to the NFC reader, receiving at least one user input via the input device indicative of a shelf-life parameter for content of the storage container, and storing data indicative of an expiration date for the content of the storage container.

The “user input indicative of a shelf-life parameter” may be any information which is relevant in determining an expiration date for the corresponding content of the storage container, including but not limited to: the type of product, the production date of the product, the storage date of the product, and the storage conditions under which the product is to be kept.

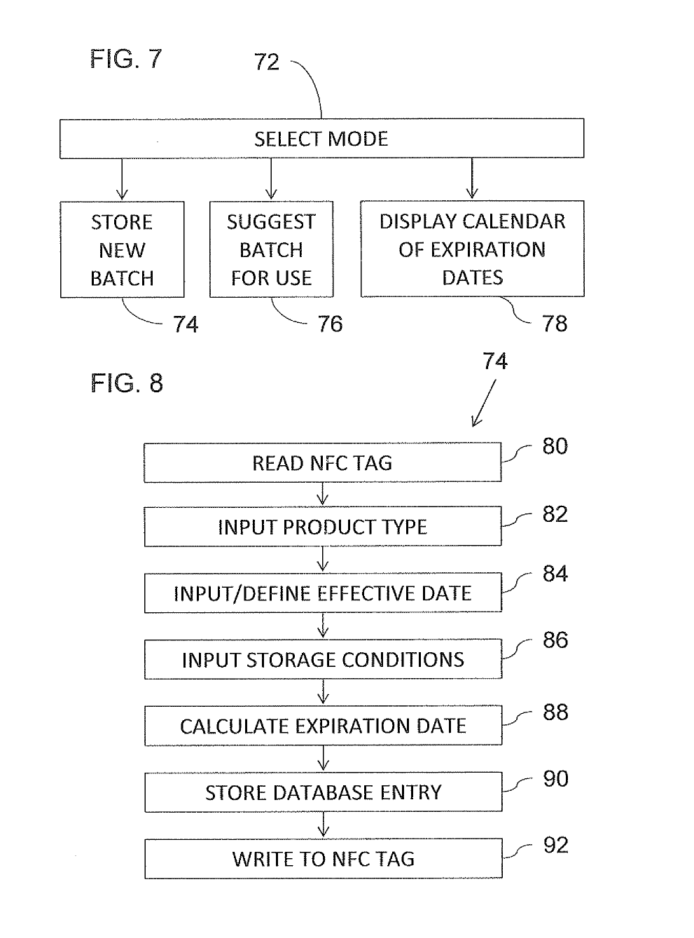

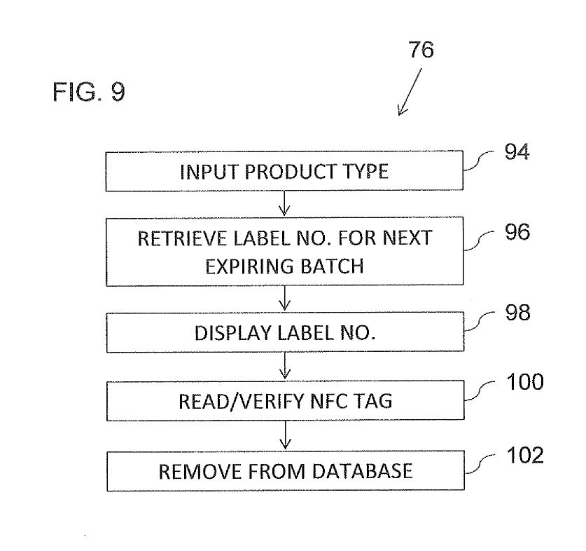

Turning now to FIGS. 7-9, the function (an implicitly the corresponding configuration of the monitoring system 70) according to one exemplary implementation of this aspect of the present invention will not be described in more detail. Referring first to FIG. 7, the implementation illustrated here provides an initial start-up screen (step 72) from which one of three different modes may be selected: a “store new batch” function 74 further detailed in FIG. 8, a “suggest batch for next use” function 76 further detailed in FIG. 9, and a “display calendar of expiration dates” mode 78.

On a user input selecting the “store new batch” function 74, monitoring system 70 initiates a sequence such as that exemplified in FIG. 8. Specifically, the sequence includes reading NFC tag 66 (step 80) and then inputting or defining information indicative of a shelf-life parameter for content of the storage container. This may include inputting the product type (step 82), inputting or otherwise defining an effective date as a basis for calculating an expiration date (step 84), and inputting information about the storage conditions under which the storage container is to be stored (step 86).

It should be noted that not all of these parameters need necessarily be set by user input. For example, in an implementation provided specifically for use in the storing of breast milk, or any other context in which a single product type is to be stored, the “product type” may be preset or known quantity programmed into the system. Similarly, the “effective date” will typically assume a default value of today's date at the time of reading the corresponding NFC tag. An option may be provided to update or manually set the date, to allow for entry into the system of batches which were produced at an earlier date, or which otherwise have an earlier effective date.

The “effective date” for calculation of an expiration date of a product may correspond to various events, including but not limited to: a production date of the content of the storage container; a storage date of the content of the storage container; and a date of opening of a product marked for use only within a given time from opening.

In certain preferred implementations, at step 86, the user inputs an indication to define storage conditions under which the storage container will be kept. Typical options include two or more of the following: room temperature storage; refrigerated storage; ice-compartment storage; and deep-freeze storage. Optionally, more complex combinations may be provided, such as the possibility to specify how long the product has been at room temperature prior to refrigeration or freezing.

Then, at step 88, monitoring system 70 calculates an expiration date until which the product is expected to remain in good condition for use. For various key applications of the invention, such as for storage of breast milk, extensive data exists for modeling the safe storage periods for the milk under various different storage conditions. Similarly, for a wide range of food products and medications, appropriate “shelf-life” for at least the recommended storage conditions is often indicated on the product packaging. Where the invention is to be applied to a broader range of products under a range of different storage conditions, empirical data can be derived from simple experiments in order to define suitable expiration date calculations for each food type and storage conditions options.

As an alternative to some or all of inputs 82, 84 and 86, an option may be provided to enter directly either an expiration date or a date of opening plus a “use within period X after opening” value, thereby defining an expiration date more directly. Such an approach may be particularly relevant for managing various medications and/or domestic food products which recommend that the product be used only for a given period from the time of opening.

Once the expiration date has been determined, it is stored to a database (step 90) and/or to NFC tag 66 (step 92) according to one or both of the approaches discussed above with reference to steps 40 and 42 of FIG. 4. In this context, particularly where a storage container is likely to be reused for storing a subsequent batch of contents, the NFC tag is preferably not locked after writing.

As in the first aspect of the invention, one particularly preferred implementation of monitoring system 70 employs hardware components of a mobile communications device appropriately configured by installation of a software package. FIG. 5 shows schematically monitoring system 70 with a sample graphic user interface screen for input of data during a new batch storage process.

Turning now to FIG. 9, this illustrates an optional implementation of a sequence corresponding to the “select next batch for use” function 76. Firstly, if monitoring system 70 is used with more than one type of product, the product type is selected user input (step 94). The database of stored batches of that product is then searched to find the batch with the closest upcoming expiration date (step 96) and to display a prompt to the user indicating a visual identifier for the desired storage container (step 98). Preferably, the sequence continues with a verification process according to which the retrieved storage container is brought into proximity to the NFC tag reader which reads the tag to verify that the correct batch has been retrieved (step 100). After verification, the entry is removed from the database of available batches (step 102), either by deletion of the data or by marking the entry as “used”.

Clearly, alternative implementations may be used to provide additional or alternative tools to facilitate retrieval of the correct batch, or selection of any one of a subset of storage containers that fall within a preferred range of expiration dates. For example, monitoring system 70 may assume a scanning mode in which the tag reader is brought sequentially into proximity with each storage container in turn, scanning and identifying each, and generating an audio signal (“beep” or the like“) on encountering a storage container from the desired subset. A similar scanning process may also provide an indication to single out any expired batches which should be removed and disposed of.

Finally, according to a further option corresponding to function 78 in FIG. 7, monitoring system 70 may provide a calendar display in which expiration dates of the various stored batches of a given product type are displayed graphically. This may be a valuable tool for planning supply and demand over a given period.

To the extent that the appended claims have been drafted without multiple dependencies, this has been done only to accommodate formal requirements in jurisdictions which do not allow such multiple dependencies. It should be noted that all possible combinations of features which would be implied by rendering the claims multiply dependent are explicitly envisaged and should be considered part of the invention.

It will be appreciated that the above descriptions are intended only to serve as examples, and that many other embodiments are possible within the scope of the present invention as defined in the appended claims.

What is claimed is:

1. A system for monitoring a period of use of components, the system comprising:
(a) a plurality of components each having an integrated or attached NEC tag; and
(b) a monitoring system comprising:
(i) a processing system comprising at least one processor coupled to a data storage device,
(ii) an NEC reader associated with said processing system, and
(iii) an output device for providing information to a user,
wherein said monitoring system is configured to:
(A) read data from an NEC tag of one of said components brought into proximity to said NFC reader;
(B) determine from said read data whether said component has been previously used;
(C) for a previously used component, generate via said output device an indication to a user of a period-of-use status; and
(D) for a component not previously used, store data indicative of a first date of use of the component.

2. The system of claim 1, wherein said monitoring system is configured to store said data indicative of a first date of use by writing said data to said NEC tag.

3. The system of claim 2, wherein said monitoring system is further configured, after writing said data to said NFC tag, to lock said NFC tag.

4. The system of claim 1, wherein said indication of a period-of-use status includes at least one indication selected from the group consisting of: a time until recommended replacement; a recommended date for replacement; and a due-for-replacement indication.

5. The system of claim 1, wherein said plurality of components are interchangeable components configured for use with a device, and wherein said monitoring system is integrated as a part of said device.

6. The system of claim 5, wherein each of said NFC tags is pre-programmed with an expiration date for use of the corresponding component, and wherein said monitoring system is further configured to generate an expiration output if said expiration date has passed.

7. The system of claim 5, wherein each of said NFC tags is pre-programmed with a compatibility code indicative of compatibility between said corresponding component and said device, and wherein said monitoring system is further configured to verify said compatibility code.

8. The system of claim 5, wherein said components are interchangeable components of a breast pump, and wherein said device includes a suction-generating pump.

9. The system of claim 5, wherein said components are interchangeable components for receiving blood samples, and wherein said device includes a blood sugar monitor.

10. The system of claim 5, wherein said components are interchangeable components of a drug delivery system, and wherein said device includes a drug delivery pump.

11. The system of claim 5, wherein said components are interchangeable filter units, and wherein said device is a water filter.

12. The system of claim 1, wherein said monitoring system is implemented using hardware components of a mobile communications device configured by installation of a software package.

13. A method for monitoring a period of use of components, the method comprising the steps of:
(a) providing a plurality of components each having an integrated or attached. NFC tag; and
(b) providing a monitoring system comprising:
(i) a processing system comprising at least one processor coupled to a data storage device,
(ii) an NFC reader associated with said processing system, and
(iii) an output device for providing information to a user,
(c) reading data from an NFC tag of one of said components brought into proximity to said NFC reader;
(d) determining from said read data whether said component has been previously used;
(e) for a previously used component, generating via said output device an indication to a user of a period-of-use status; and
(f) for a component not previously used, storing data indicative of a first date of use of the component.

14. A system comprising:
(a) a plurality of storage containers each having an integrated or attached NFC tag; and
(b) a monitoring system comprising:
(i) a processing system comprising at least one processor coupled to a data storage device,
(ii) an NFC reader associated with said processing system,
(iii) an input device for receiving inputs from a user, and
(iv) an output device for providing information to a user,
wherein said monitoring system is configured to:
(A) read data from an NFC tag of one of said storage containers brought into proximity to said NFC reader;
(B) receive at least one user input via said input device indicative of a shelf-life parameter for content of said storage container; and
(C) store data indicative of an expiration date for the content of said storage container.

15. The system of claim 14, wherein said monitoring system is configured to store said data indicative of an expiration date by writing said data to said NFC tag.

16. The system of claim 14, wherein said monitoring system is implemented using hardware components of a mobile communications device configured by installation of a software package.

17. The system of claim 14, wherein said monitoring system is configured to be responsive to said at least one user input to define a type of content of said storage container.

18. The system of claim 14, wherein said monitoring system is configured to be responsive to said at least one user input to define at least one of the group consisting of: a production date of the content of said storage container; and a storage date of the content of said storage container.

19. The system of claim 14, wherein said monitoring system is configured to be responsive to said at least one user input to define a storage condition selected from at least two options, wherein said at least two options belong to the group consisting of: room temperature storage; refrigerated storage; ice-compartment storage; and deep-freeze storage.

20. The system of claim 14, wherein said storage containers are interchangeable bottles for use with a milk-pump system, and wherein said NFC tags are integrated into said interchangeable bottles.

21. The system of claim 14, wherein said NFC tags are integrated into stickers for attachment to said storage containers.

22. A method comprising the steps of:
(a) providing a plurality of storage containers each having an integrated or attached NFC tag; and
(b) providing a monitoring system comprising:
(i) a processing system comprising at least one processor coupled to a data storage device,
(ii) an NFC reader associated with said processing system,
(iii) an input device for receiving inputs from a user, and
(iv) an output device for providing information to a user,
(c) read data from an NFC tag of one of said storage containers brought into proximity to said NFC reader;
(d) receive at least one user input via said input device indicative of a shelf-life parameter for content of said storage container; and
(e) store data indicative of an expiration date for the content of said storage container.
